(19) United States
(12) Patent Application Publication
(10) Pub. No.: US 2006/0074890 A1
(43) Pub. Date: Apr. 6, 2006

(54) Process for matching vendors and users of search engines so that more valuable leads are generated for vendors

(76) Inventor: Manjula Sundharam, Nashua, NH (US)

Correspondence Address: Manjula Sundharam, 29 Chadwick Circle Apt F, Nashua, NH, 03062, US

(21) Appl. No.: 11/244,793

(22) Filed: Oct. 6, 2005

Related U.S. Application Data
(60) Provisional application No. 60/616,468, filed on Oct. 6, 2004.
(60) Provisional application No. 60/620,199, filed on Oct. 19, 2004.

(51) Int. Cl. G06F 17/30

(52) U.S. Cl. 707/3

(57) ABSTRACT

An improved method for generating revenue from web-searches. Instead of showing advertisements, this method implements an RFQ or request-for-response mechanism that is linked to searches. It provides vendors with highly qualified leads and users with a better search experience.

### CROSS-REFERENCE TO RELATED APPLICATIONS

This application claims the benefit of Provisional Patent Application Ser. No. 60/616,468 filed on Oct. 6, 2004 and Provisional Patent Application Ser. No. 60/620,199 filed on Oct. 19, 2004 which are incorporated herein by reference.

### FEDERALLY SPONSORED RESEARCH

Not applicable.

### SEQUENCE LISTING OR PROGRAM

Not applicable.

### BACKGROUND OF THE INVENTION

This invention deals broadly with the subject of generating revenue for search-engines.

A search-engine is a system used by people who wish to retrieve information from the web. To retrieve information, they enter a set of words (as a phrase, or a full query) into the search system. The search-engine uses this query to look up documents that match and presents them to the user.

A search-engine is valuable to users because it allows them to access information by entering queries. These queries that users enter are an indication of each user's intention at that time. A user who enters a query about heart medication is probably interested in treating a heart condition and might be interested in purchasing medications.

Knowledge of user intention is valuable to vendors who may be able to sell the user goods and services that are relevant to the user's intention. For example, a vendor of heart medications may wish to contact the person who searched for information on heart medications.

In other words, a search-engine has information about each user's specific interests and intentions. Collectively this information about intentions is very valuable for vendors. Vendors are willing to pay for high-quality sales leads that will help their businesses grow. The challenge for search-engines is to generate the highest quality leads for vendors.

The better the leads, the more vendors will be willing to pay, thereby resulting in higher revenues for search-engines.

Until now, search engines have generated revenue by allowing vendors to advertise based on query-keywords. For example, a vendor may purchase the right to show advertisements on the keywords “heart medication”. Whenever a user enters a query containing those words, the advertisement is shown.

If the user clicks on the advertisement, then the vendor gets a visitor who has shown some interest in what the vendor is selling.

However, there are some problems with this approach. The user has only entered a query consisting of a few words. Short queries are ambiguous. Perhaps the user was researching heart medications to write an article about risks. In such situations, though the user has entered keywords that are relevant to the vendor's business, the user is not a real prospect. Therefore, search engine advertisements are not a precise way to match buyers with sellers.

In sales parlance, the process of verifying a prospect's interest in buying is called “qualifying a lead”. So search engine advertisements provide vendors with partially qualified leads, not fully qualified leads.

On the other side of the interaction, the user's experience in looking for a vendor by clicking on search advertisements is also less than perfect. To compare a number of different vendors, the user needs to click on a number of advertisements, read the websites, prepare a shortlist, call each vendor on the shortlist and verify that they are really willing to provide the product or service at the desired price-point. Finally after a lot of manual research, the user will have sufficient information to make a buying decision. The process of choosing a vendor through clicking on search-advertisements is labor intensive.

The invention described here avoids these problems. Its advantages are specifically as follows:
1. Unlike search engine advertisements, it produces very thoroughly qualified leads for vendors. So each lead that this system produces is more valuable for vendors.
2. It is easier for would-be buyers to select vendors.

Instead of investigating a large number of vendors by manually contacting each one, this system streamlines the process of choosing the right vendor.
3. This invention uses detailed requirements obtained from a buyer to find an appropriate vendor, so the marketplace which this system fosters is more accurate and efficient.
4. Since this system provides more valuable leads for vendors, vendors will be willing to pay the search-engine more for each lead. So it increases search-engine revenues.
5. This system can be used with small devices whose display screens are too small to allow a user to scan multiple advertisements before clicking on any of them.
6. This system uses a small constant amount of real-estate on the search-engine results page (SERP). So there is no limit on how many vendors can be included in the lead generation system. This is superior to advertisements where each advertisement takes up valuable space and devoting too much space to advertisements can annoy search-users.

### SUMMARY

The general principle is as follows: We ask the search user to explain in complete detail the kind of vendor they are trying to find. For example if the user is looking for a graphic designer, then the user may specify the geographic location, the kind of experience the designer must have already had, the budget, and so on.

Once we have the complete requirements, we show these requirements to a large number of vendors (possibly hundreds) and ask the vendors to bid on the opportunity to contact the user. This is something like an auction. The full description of the user's requirements is like a sales lead and the vendor is bidding in an auction to buy the sales lead. The set of vendors to show the requirements to is determined by examining the query or the requirements.

Once a set of vendors have been identified who are willing to pay for the lead (according to criteria that maximize revenue or other such measurement) we allow the vendors to contact the user. This may be done by giving the vendor the contact information of the user. Alternatively, we can use an anonymizer service that hides the contact information of the user, but yet allows the vendor to contact the user in a controlled manner.

The schematic of a system that implements this invention is shown in FIG. 11. A user 1110 uses a search engine 1120. If the search system (using predetermined rules) determines that the user is looking for a vendor, then the search system obtains the contact information of the user and full query details. The search system also assigns the user a Globally Unique Identifier (GUID) to help identify the user during later interactions. The GUID and the query details are shown to vendors 1140. The appropriate set of vendors who are to be shown the query details is computed by analyzing words in the query. The GUID and the associated contact information are sent to a payment-collecting messaging system 1130. The messaging system stores the association between the GUID and the contact information in an internal database for later use. This tolled messaging system implements the auction process by which a suitable set of paying vendors are selected. The tolled messaging system collects payment from each selected vendor and conveys their sales message to the user (prospect) 1110. The vendors identify the user to whom each message should be sent by giving the tolled messaging system the user's GUID along with the response message and the payment. The messaging system's internal database is looked up to determine how to convey the response message to the user.

### DRAWINGS

FIG. 1 is a flowchart describing a process for lead management in an automated search engine.

FIG. 2 is a flowchart describing a process for lead management in a human-powered search system.

FIG. 3 is a flowchart describing the details of a process that implements step 150 of FIG. 1 in the situation when an email anonymizer is used.

FIG. 4 is a flowchart describing the details of a process that implements step 180 of FIG. 1 in the situation when an email anonymizer is used.

FIG. 5 is a flowchart describing the details of a process that implements step 150 of FIG. 1 in the situation when a telephone anonymizer is used.

FIG. 6 is a flowchart describing the details of a process that implements step 180 of FIG. 1 in the situation when a telephone anonymizer is used.

FIG. 7 is a flowchart describing the details of a process that implements step 150 of FIG. 1 in the situation when cookie-based message transmission is used.

FIG. 8 is a flowchart describing the details of a process that implements step 180 of FIG. 1 in the situation when cookie-based message transmission is used.

FIG. 9 is a flowchart describing the details of a process that implements step 150 of FIG. 1 in the situation when the user calls in with a query by telephone or sends a query by email.

FIG. 10 is a flowchart describing the details of a process that implements step 180 of FIG. 1 in the situation when the user calls in with a query by telephone or sends a query by email.

FIG. 11 is a schematic describing the components of the preferred embodiment of this invention.

### DETAILED DESCRIPTION

A search engine provides a valuable service to users. Users are able to use a search engine to get the information they need from the web. Search engines accept queries from users and provide a results page that lists relevant web sites.

The information that users provide to search engines about their own interests is very valuable. Currently search-engines derive a substantial portion of their revenues by monetizing the information they collect from users about their interests. The queries that users enter into search-engines is a good indication of their interests. So search-engines currently use a trigger mechanism that watches for certain keywords to occur in the queries. If the keywords occur, then appropriate advertisements are shown to the user. Since user-interests are used to determine the advertisements to show, the advertising messages are more relevant for users and when users choose to follow the links, vendors obtain good quality leads.

Problems with current mechanisms that match vendors and buyers on search-engines stem from the inaccuracy of the advertising mechanism. The invention described here removes many of the inaccuracies that are inherent in search-engine advertising.

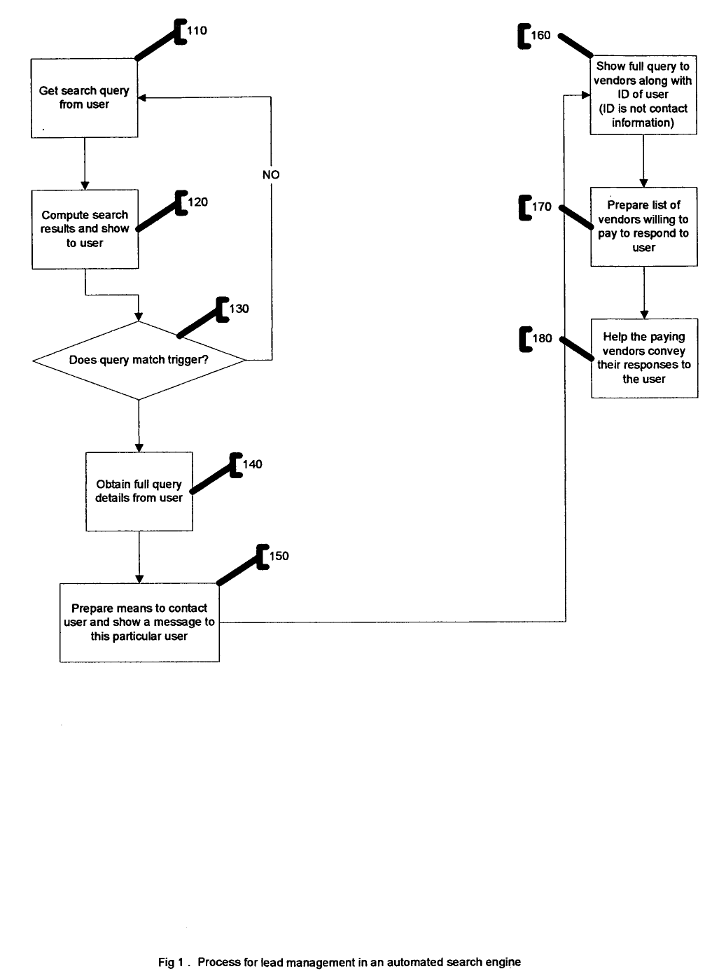

The solution presented here is to integrate search-engines with a fee-based “Request-For-Quotes” (RFQ) mechanism as shown in FIG. 1. Henceforth the term RFQ is used to include other similar requests for responses from vendors, such as “Request-For-Proposals” (RFP), requests for more information, and so on. When a user enters a search query, step 110, we compute the results and show them to the user, step 120. In addition to computing search results, we check to see if the query indicates that the user's interests are valuable to any vendors by matching against a trigger mechanism, step 130. If the query indicates completely non-commercial subject matter, we ignore it. Otherwise, we invite the user to provide full details about their requirements, step 140. These requirements constitute a RFQ for vendors. Our system generates revenue by selling vendors the ability to respond to this RFQ. So our next step is to prepare the means to contact the user and show the user responses to the RFQ from vendors, step 150. There are many alternative implementations of step 150 as will be discussed later in this section.

Once we have obtained the RFQ from the user and prepared some way to send the vendors' responses to the user, we move on to the business of selling the RFQ to vendors.

The first step in selling the RFQ to vendors is to determine a subset of vendors who are likely to be interested and show them the RFQ as detailed in step 160. The process of “determining a subset of vendors who are likely to be interested” can be performed by examining the query. This is done in exactly the same way that current search-engines determine the set of appropriate advertisements to show based on a search query. Since this process is well-known in the art when used for advertisements, it will not be discussed further here.

Since we want to allow vendors to respond to the RFQ only through us, we create a unique ID for each user and use that ID to identify users. The process of computing a unique identifier or GUID is well-known in the art. Later in this section we will discuss how GUIDs are associated with users within step 150.

Once vendors see the RFQ (either through email, or possibly through a forum-like mechanism) some of them indicate a willingness to buy the RFQ, step 170. Once we have the list of vendors who want to buy the RFQ, we collect payment from them and arrange to convey their response to the user who had submitted the RFQ, step 180.

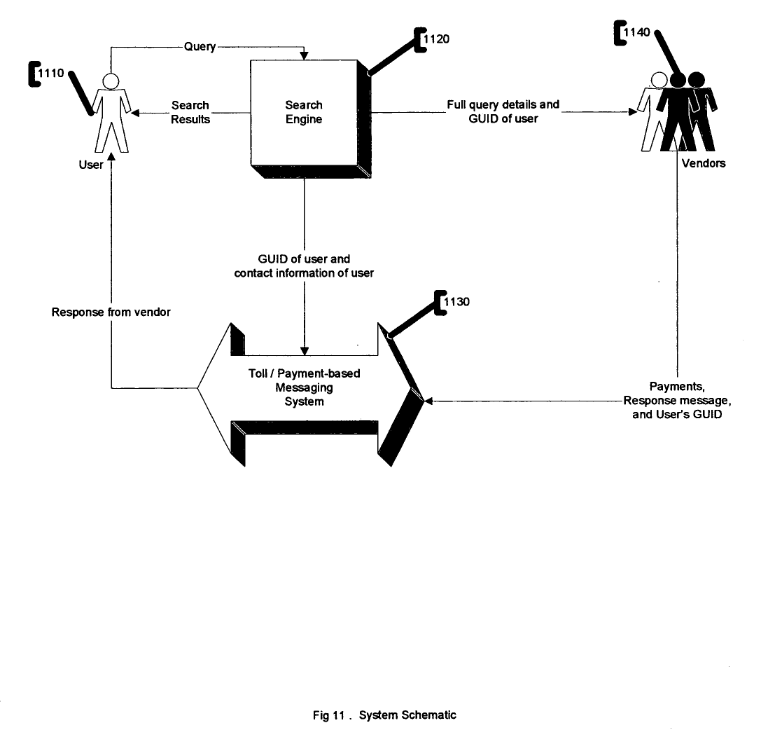

FIG. 11 is a schematic showing the components of a system that implements the process described in FIG. 1. The user 1110 enters a query into a search-engine 1120 and obtains search results. If the user's query is determined to be of interest to vendors, the search-engine gets full query details as well as some way to contact the user. The user is associated with a GUID. The GUID and full query details (the RFQ) are sent to the vendors 1140. In addition, the GUID and the contact information of the user are stored in a controlled fee-based messaging system 1130. Vendors who wish to respond to the RFQ can only do so through the fee-based system 1130. Once they pay a fee, their response is delivered to the users 1110.

In addition to integrating an RFQ mechanism into automatic search-engines, we can integrate an RFQ system into manual search-systems as well. A manual (or human-powered) search system is one that employs human experts to search for information on the web. The advantage of human-powered searches is that human search-service-providers can understand the full context and meaning of a fully specified query. The expert searchers can engage the user in a conversation, find out exactly what they want to know, and then deliver exactly the required results with no irrelevant results or inaccuracies.

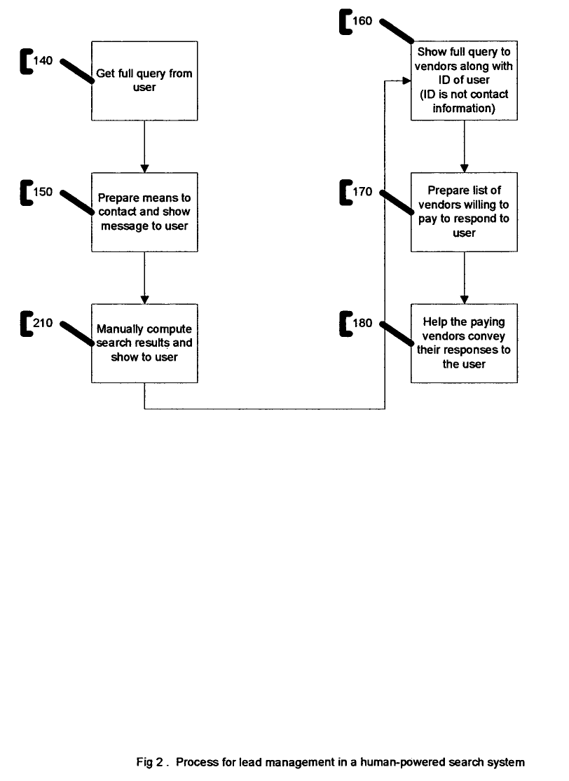

FIG. 2 details how this invention may be implemented with human-powered search systems. To start with, the system collects complete search-requirements from the user, step 140. Since a human-powered system is very accurate and uses human-intelligence, the user can be asked to give full requirements upfront. If the query is commercial in nature, then these requirements are equivalent to an RFQ.

Once we have the requirements, we still need to be able to deliver vendor-responses to the user, so we collect enough information (either by setting cookies, or by directly asking the user for contact information) to show the user the vendor responses, step 150. Since we are discussing a human-powered search system, we compute the search results and send them to the user, step 210. In the next steps, we show the RFQ to vendors, step 160, collect payment from vendors who decide to purchase the ability to respond to the RFQ, step 170, and finally convey the responses to the user, step 180.

There are a number of alternatives for the implementation of step 150 and step 180. A simple implementation would be to store the email address (or other contact information) of the user in a database in step 150 and to give that information to the vendor in step 180 so that the vendor can directly contact the user.

But not all users will want their contact information to be given to vendors. So the use of an anonymizer (something that protects the contact information of the user from uncontrolled access) may be required.

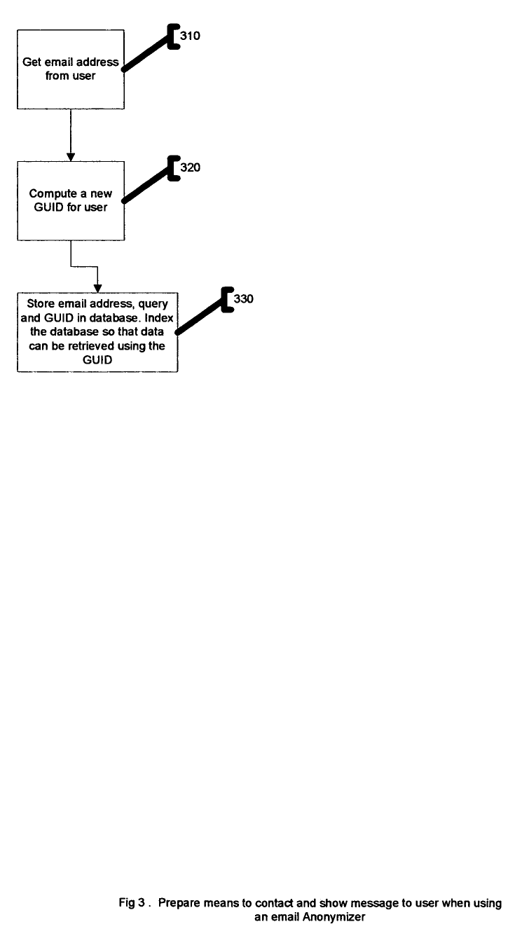

If we are collecting the email address of users, then step 150 may be implemented as shown in FIG. 3. First we get the email address from the user, step 310. Next we compute/retrieve a new ID for the user, step 320. Then we associate the email address with the GUID in a database, step 330. Steps 310, 320 and 330 together ensure that a specific user can be identified to vendors by a public GUID, but the user's contact information is held private within our system. Our system can send emails to specific users (identified by GUID) by looking up the email address from the database, but vendors cannot do so on their own.

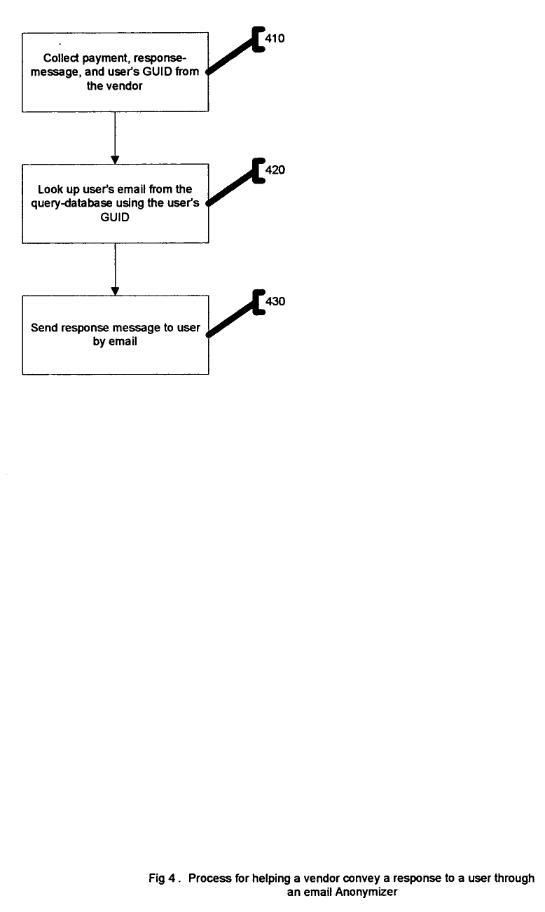

FIG. 4 details the implementation of step 180 with an email anonymizer. A vendor specifies the user and the RFQ that they are responding to through the GUID, step 410. When providing the response, vendors also pay the search-engine. Next we look up the user's email (that we stored in step 330) from the database, step 420. Finally we send the vendor's response to the user, step 430.

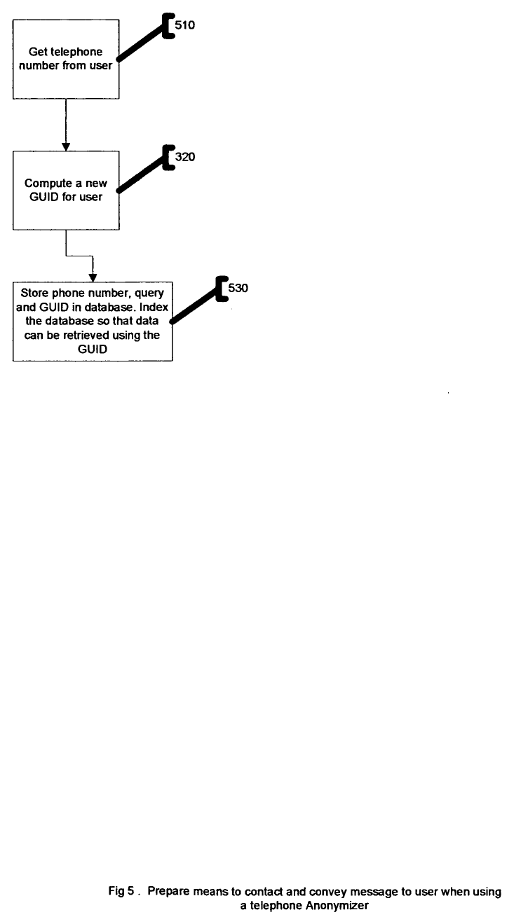

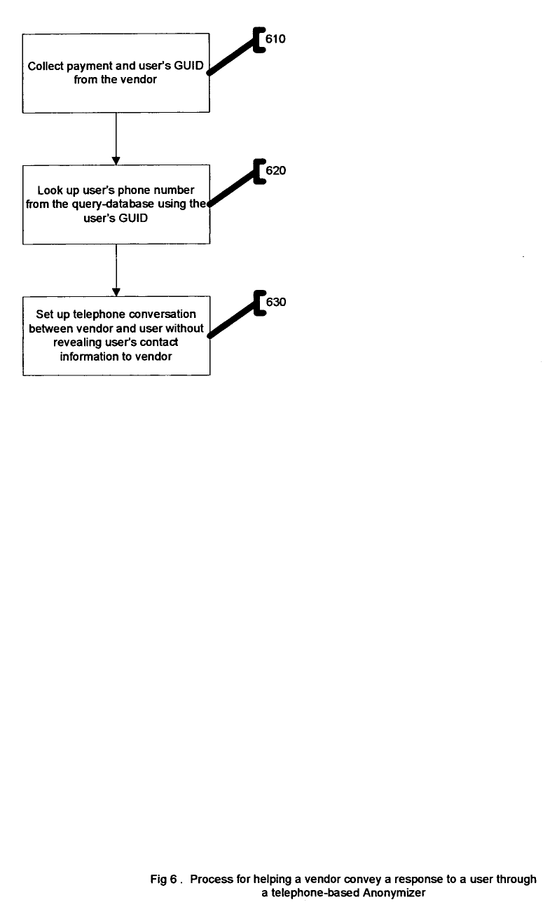

If the user wishes to interact over the telephone, then step 150 may be implemented as shown in FIG. 5. First we get the user's contact information, in this case, the telephone number in step 510. Next compute a new GUID in step 320. As before, we store the contact information along with the GUID in a database, step 530. The corresponding implementation of step 180 (for telephone anonymizer) is shown in FIG. 6. We collect payment and find out which user the vendor wants to contact, step 610. Then we find out how to contact the user by looking up the previously recorded (step 530) data and setting up a telephone conversation, step 630.

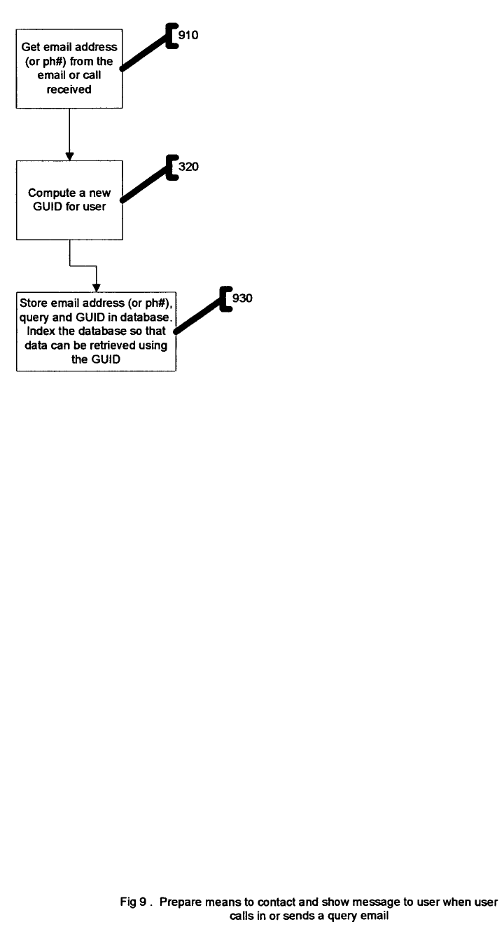

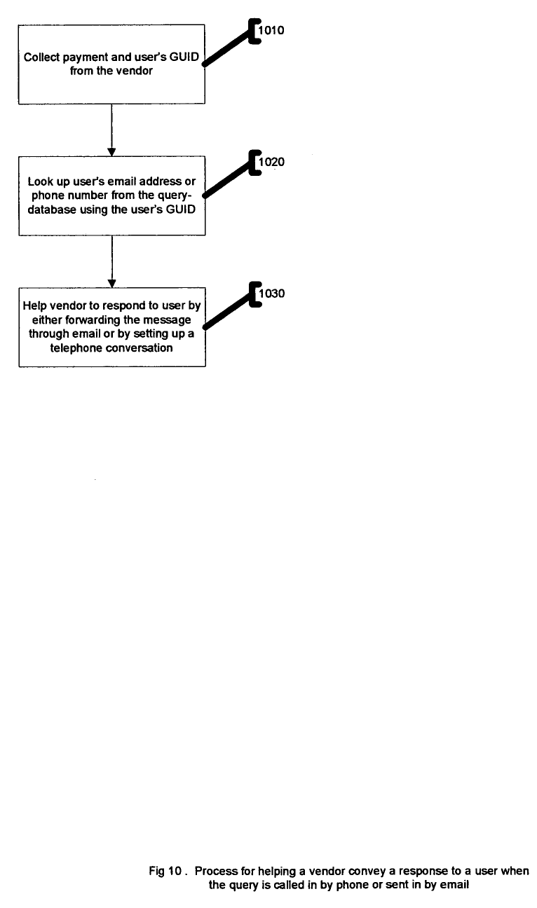

Instead of using a traditional search-engine interface with a GUI, we can choose to use an email-based search system. The user sends queries by email (or by telephone) and receives results by email (or phone). In this case, step 150 is implemented as shown in FIG. 9. The received email query will contain the reply-to address of the user, step 910. As in other cases, we compute a GUID, step 320. Finally we store the information in a database, step 930. In FIG. 10 details of how we convey the vendor's response to the RFQ is shown. We collect the payment for a specific user in step 1010, look up the user's contact information in step 1020, and convey the response in step 1030.

A more sophisticated way to deal with a user's RFQ would be to use an alternative means of messaging that is integrated directly into the search interface. Instead of sending emails to the user, we may implement a forum where users can post RFQs for free, but vendors pay to respond. Other variations are also possible, and one where messaging is accomplished through web-browser cookies will be discussed below.

The idea is this: When the user submits an RFQ through a web-browser, we set a unique cookie on their browser. Since users typically use a search-engine often, we can safely assume that the user will visit the search-engine again at some later point in time. At that time, we use the cookie to lookup any pending messages that need to be shown to that specific user and display those messages on the search-page.

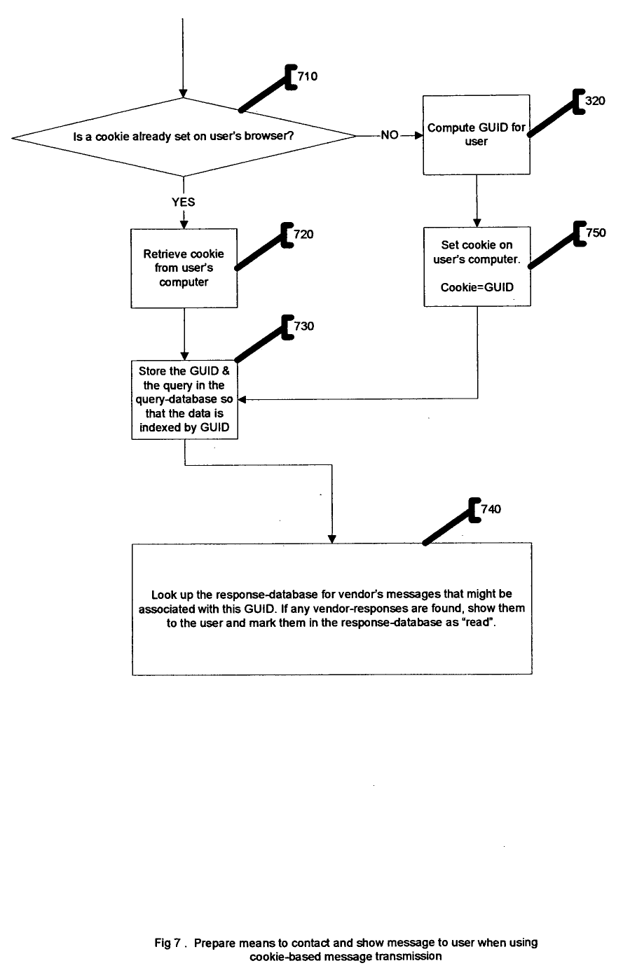

A mechanism like this does not require the user to explicitly provide contact information and guarantees the user their privacy. If we use a cookie-based messaging system, step 150 will be implemented as detailed in FIG. 7.

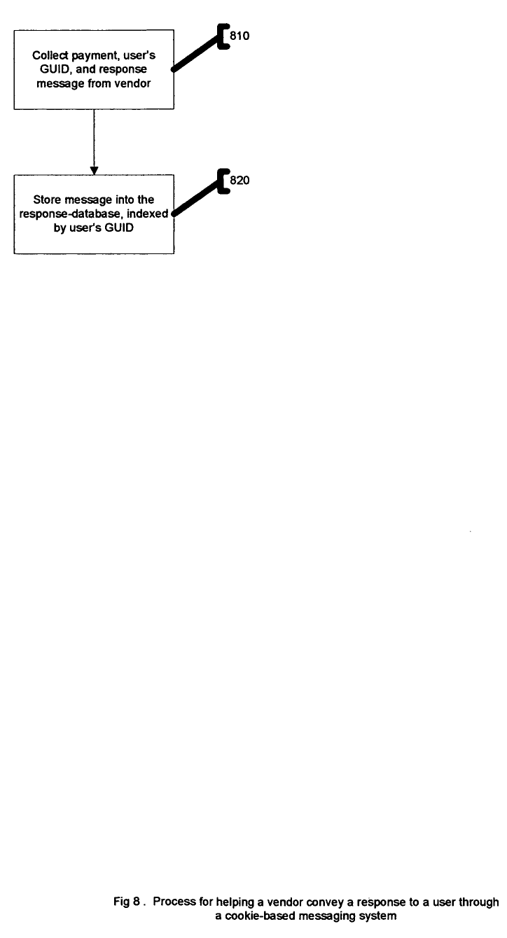

First we check to see if the user's identity is already stored as a GUID cookie on the web-browser of the user, step 710. If not, we compute a new GUID, step 320, and store it in a cookie, step 750. If the cookie already exists, we simply retrieve it from the browser, step 720. Once we have the GUID, we store an association between the GUID and the RFQ in step 730. Finally we check to see if any responses to earlier RFQs submitted by the user are available. If they are available, we show them to the user and record the fact that we have already shown them, step 740. Correspondingly, step 180 is implemented as shown in FIG. 8. First we collect payment and responses from vendors, step 810. Next we store the responses in a database, step 820, in a form that allows them to be shown to the user in step 740 as discussed earlier.

The discussion so far has concentrated on the notion that vendors pay only when they respond to a user's RFQ. (As a reminder we point out that in this entire discussion, the term RFQ is used to mean any request for information). Instead alternative payment arrangements can be easily made. Vendors can be asked to pay only if the user wishes to go ahead with some response. Or vendors may pay a fixed fee for unlimited responses. Vendors may also be charged according to the query words on which they are shown RFQs. In addition, vendors may be charged for the number of RFQs they view rather than the RFQs to which they actually respond.

This method can be applied not only to search-engines that index the entire web, but also to engines that cover only a portion of the web, and even engines that are restricted to just one web-domain. It can also be used in directories (such as dmoz) that contain vendor descriptions in addition to other general non-commercial content.

So far we have only discussed the fact that vendors pay to get their message to users. There are many alternatives possible here. If we wish to limit the number of total responses to (say) 5, we can arrange an auction where vendors are able to bid for each query, and only the top 5 bids are chosen. Other possibilities include having an auto-increment price. The price of responding to a query can start out low (possibly even zero) and then increase with each vendor's response. So vendors who are quick to respond can do so for a low cost. Other who take longer, pay more. This also limits the number of vendors who respond because the cost of each query will soon become too high. Fixed price arrangements where a vendor can respond to any number of queries within a certain time-period (perhaps a week) are also possible.

I claim:

1. A method of generating revenue in a search-engine comprising
(a) obtaining a search query from a user,
(b) responding to said search query with computed search results,
(c) determining a set of vendors who are likely to be interested in said search query,
(d) allowing said set of vendors to view said search query,
(e) obtaining responses from one or more members of said set of vendors,
(f) obtaining payment or promise of payment from those vendors who have provided said responses,
(g) conveying said responses to said user,
whereby vendors are able to send their sales message precisely targeted to those individuals who are very likely to need their product or service.

2. An automated computational system comprising
(a) a search-engine means that indexes the web or a subset of the web,
(b) a means of input by which said search-engine may be given a query by a user,
(c) a means to examine said query, determine a set of vendors likely to be interested in said query, and show said set of vendors said query,
(d) a means to accept payment from any member of said set of vendors,
(e) a means to convey sales messages from the paying vendors to said user,
whereby vendors are able to send their sales message precisely targeted to those individuals who are very likely to need their product or service.

3. The method of claim 1 wherein the step of obtaining a search query from a user further comprises
(a) obtaining an initial short query for the purpose of processing in said search-engine,
(b) analyzing the words in said query to determine if said query is likely to be of interest to any vendors,
(c) if said query is determined to be interesting to any vendors, obtaining from said user a more complete query and description of requirements.

4. The method of claim 1 wherein the step of conveying said responses to said user is performed through an anonymizer that protects said user's contact information from becoming known to any vendor.

5. The method of claim 1 wherein the step of obtaining payment or promise of payment from those vendors who have provided said responses further comprises
keeping track of the number of responses that have been conveyed to said user for said query and
increasing the fee collected for each response as the number of responses increases.

6. The method of claim 1 wherein the step of obtaining payment or promise of payment from those vendors who have provided said responses further comprises
running an auction in which vendors are invited to bid and
accepting payment and responses only from the top bidders.

7. The automated computational system of claim 2 wherein said means to convey sales messages from the paying vendors to said user further incorporates an anonymizer that protects the contact information of said user from being revealed to any vendor.
